(19) United States
(12) Patent Application Publication
(10) Pub. No.: US 2008/0279732 A1
(43) Pub. Date: Nov. 13, 2008

(54) Exhaust as Treatment

(75) Inventors: James Coates, Cambridgeshire (GB); Martin Stanley Johnson, Warwickshire (GB)

Correspondence Address: THE OLLILA LAW GROUP LLC, 2060 BROADWAY, SUITE 300, BOULDER, CO, 80302, US

(73) Assignee: IMI VISION LIMITED, Alcester, Warwickshire (GB)

(21) Appl. No.: 11/815,480

(22) PCT Filed: Feb. 16, 2006
(86) PCT No.: PCT/GB2006/000543

§ 371 Date: Mar. 18, 2008

(30) Foreign Application Priority Data
Feb. 16, 2005 (GB) 0503181.0
Mar. 23, 2005 (GB) 0505916.7
Sep. 22, 2005 (GB) 0519322.2

(51) Int. Cl. C01C 1/08; F01N 3/02; F01N 3/20

(52) U.S. Cl. 422/148; 60/320; 60/286

(57) ABSTRACT

Apparatus for generating an ammonia-containing gas is described for use in the selective catalytic reduction of NOx contained in the exhaust gases of an IC engine. The apparatus has a hydrolysis reactor (101) for containing an aqueous solution of urea that is heated, in use, to an elevated temperature by way of heat exchange with the exhaust gases to hydrolyse the urea and liberate ammonia containing gases. A pressure control valve (105) is operable between a substantially closed position for enabling the pressure of the ammonia-containing gas to attain a predetermined elevated pressure within the reactor (101) and an open position when the gas is above the predetermined pressure. A reservoir (106) receives all of the ammonia-containing gas discharged from the reactor (101) when the pressure control valve (101) is in its open position and has an outlet for feeding ammonia-containing gas to the exhaust gases. The reservoir (106) stores ammonia-containing gas during operation of the IC engine and, following the IC engine being switched off, ammonia-containing gas condensate. On cold start-up of the IC engine, the ammonia-containing gas condensate is converted into ammonia-containing gas for feeding to the exhaust gases.

The present invention relates to an apparatus for reducing emissions of Nitrogen oxides (NOx) in exhaust gasses of an internal combustion (IC) engine.

The introduction of reagents into the flow of an exhaust gas of an IC engine prior to the gas passing through a catalyst in order to effect selective catalytic reduction (SCR) of NOx is well known.

The current industry solution is to inject a liquid reagent into the hot exhaust gas where it decomposes into ammonia which then reacts with NOx in an SCR catalyst converting it to harmless substances (wet spray systems). The liquid reagent is, at ambient temperatures, a stable medium, but it decomposes at elevated temperatures to form at least ammonia gas. It is preferably an aqueous solution of urea or related substance such as biuret or ammonium carbamate, collectively referred to, and defined, herein as “urea”. While this solution to the problem provides a satisfactory result, changing legislation is requiring ever better NOx reduction and, while wet spray systems operate adequately, due to the their need for a minimum temperature exhaust gas sufficient to fully decompose the urea in the distance traveled between point of introduction and SCR catalyst, they are not well suited to start-up or idle engine conditions where the exhaust temperatures can be much cooler. Specifically, wet spray systems are operating at their limit at about 200 degrees Centigrade and during start-up and idle situations the temperature of the exhaust gas can be well below this. This means that either current systems have to be switched off during these engine conditions, and are therefore not removing the NOx, or another means has to be provided for coping with these conditions. Currently exhaust gas recirculation (“EGR”) is proposed in combination with wet spray systems to meet NOx output limits, however this results in a vehicle having to be provided with two independent systems to solve a common problem, adding expense and weight to the vehicle. In addition EGR reduces the fuel efficiency of the engine.

Several alternative solutions to wet spray systems have been proposed which produce an ammonia containing gas on board and incorporate reservoirs to temporarily store the ammonia before dosing it into the exhaust gas system. Such a systems is shown in U.S. Pat. No. 6,361,754 and while this systems may overcome the problem of dosing during idle conditions when the system has been operating for a while they do not tackle the problem of meeting start-up conditions so would still need another technology, for example exhaust gas recirculation in parallel with them.

A system is disclosed in U.S. patent U.S. Pat. No. 6,301,879 which has a cold start ammonia generator for trapping ammonium carbamate during the normal operation of the system for use in cold start up. However, the system is overly complex, requires lots of heating to keep all parts warm and is designed for a situation where only a small amount of gas is needed on start-up. This is sufficient with older type SCR catalysts which are largely inefficient at lower temperatures, but the newer catalysts perform fully at lower temperatures requiring larger volumes of ammonia to be available during the cold start cycle. In addition, as it draws off the main volume of gas produced during operation to charge the cold start, an increase in the overall production rate of the device is needed. In addition a means would be needed to evacuate air out of the ammonium carbamate trap before any gas could pass into it as it is a closed-ended vessel.

It is the purpose of the to providing an improved apparatus for the production of ammonia gas for use in normal running in cold start cycles of SCR systems for IC engines, especially but not exclusively diesel engines.

According to the present invention there is provided an apparatus for generating an ammonia-containing gas for use in the selective catalytic reduction of NOx contained in the exhaust gases of an IC engine, the apparatus comprising:

a) a hydrolysis reactor for containing an aqueous solution of urea (as hereinbefore defined)
b) means for heating the solution to an elevated temperature by way of heat exchange with said exhaust gases, whereby the urea is hydrolysed and the ammonia containing gases are liberated;
c) valve means operable between a substantially closed position for enabling the pressure of the ammonia-containing gas to attain a predetermined elevated pressure within the reactor, and an open position when the gas is above said predetermined pressure;
d) a reservoir having an inlet for receiving all of the ammonia-containing gas discharged from the reactor when said valve is in its open position, and an outlet for feeding ammonia-containing gas to the exhaust gases, the reservoir serving to store ammonia-containing gas during operation of the IC engine and, following the IC engine being switched off, ammonia-containing gas condensate; and
e) means for heating the reservoir,
the arrangement being such that on cold start-up of the IC engine, the means for heating the reservoir is operable to decompose the condensate into ammonia-containing gas.

By decomposing the condensate into ammonia-containing gas a source thereof is thereby provided at cold start-up of the IC engine for use in NOx reduction before the hydrolysis reactor reaches its normal working elevated temperature and pressure.

Preferably, during normal operation the reservoir is maintained at a pressure above the pressure within the exhaust conduit. The reservoir, by providing a store of ammonia containing gas during normal operation of the system enables a fast response to transient changes in the demand for ammonia to be dosed as the load on the engine changes. While it is relatively easy to use a system without a reservoir and where the ammonia is effectively produced “on demand” in a situation where there is little or only gradual changes in the demand on the system, in a highly dynamic operating situation such as that found onboard a commercial or a passenger vehicle there will normally be a time lag between a change in engine operating conditions and the ammonia-containing gas supply being matched to those conditions due to the finite time taken to hydrolyse the reagent “on demand”.

By placing the reservoir between the point of generation of ammonia-containing gas product and point of introduction to the exhaust, the requirement for ammonia containing gas to be dosed into the exhaust can be substantially met in real time. In addition the separation of the reservoir from the reactor ensures that the operating conditions within the reactor are kept constant, i.e. the pressure within the reactor does not fluctuate as a result of dosing the ammonia-containing gas into the exhaust, therefore resulting in a substantially consistent gas product mixture exiting the reactor.

Preferably the reactor is solely heated by thermal heat transfer with the exhaust gas effecting a simple heating system utilising the “free” energy available in the exhaust. To that end, the reactor is preferably placed within the exhaust conduit such that there is direct contact between the hot exhaust gas and at least a part of the exterior surface of the reactor.

Alternatively the reactor may be heated at least in part by electric means. Preferably the reactor is initially heated by both heat exchange with the exhaust conduit and electric means and, once the exhaust reactor is at operating temperature and pressure, the electric heating means is turned off and the reactor is maintained at operating temperature and pressure by heat exchange with the exhaust gas only.

In another alternative preferred arrangement the reactor is preheated by electric heating means prior to the IC engine being started such that the reactor can produce ammonia-containing gas substantially immediately from the time the IC engine is started.

When the IC engine is turned off there is a residual volume of ammonia-containing gas within the reservoir and the ammonia-containing gas will continue to be produced for a short time. As the reservoir cools the pressure of the ammonia-containing gas in the reservoir drops and the H₂O condenses on the surface of the reservoir. As the temperature and pressure further drop some of the ammonia and carbon dioxide will combine to produce ammonium carbamate which then dissolves in the condensed water forming a solution of ammonium carbamate. The pressure and temperature within the reactor will also drop and the gas product contained within the reactor will undergo a similar process, the aqueous ammonium carbamate mixing with the aqueous urea solution within the reactor. As the ammonia-containing gas product within the reservoir cools and condenses, the pressure within the reactor will drop to substantially atmospheric pressure, preferably slightly below atmospheric pressure, as will the pressure within the reactor, thereby substantially eliminating the danger of ammonia escaping form the system while the engine is not running. This is particularly important for mobile IC engines, for example commercial or passenger vehicles where the vehicle may be stored within an enclosed space, for example a garage where any ammonia escaping from a pressurised system would be in a contained environment creating a build up of contained ammonia.

During cold start, i.e. when the IC engine is started from ambient temperature there is a time period before the reactor will produce ammonia-containing gas product for use in the NOx reduction process resulting in a time lag before ammonia is available for use in the NOx reduction process. This time lag is the result of a combination of several factors including: the time taken for the exhaust gas to reach its normal operating temperature (compounded by the fact that IC engines are normally started under no load or very light load conditions therefore taking longer to reach normal operating temperatures), the coefficient of thermal transfer between the exhaust gas and the liquid reagent within the reactor and the ratio of volume of liquid within the reactor to head space above the liquid. The result is that meeting requirements of emission standards is difficult during initial start up. As emissions standards are becoming ever increasingly stringent, this period during which the NOx is untreated will become unacceptable.

On cold start, heat is applied to the reservoir which then acts as a secondary reactor, evaporating the condensed water and thermally decomposing the ammonium carbamate dissolved therein to create ammonia and carbon dioxide gas thus reverting the contents of the reservoir back to their original state prior to the IC engine being shut down. When operational the reservoir is maintained at an elevated temperature to prevent the gasses therein condensing. Preferably the reservoir is maintained at a substantially constant temperature.

Preferably, heat is supplied to the reservoir by heat transfer from the hot exhaust gas both during normal operation and cold start-up. For that purpose the reservoir is preferably located such that a part of it protrudes through, or forms a part of, the exhaust conduit. As the heat and time required for the cold-start reaction in the reservoir is much less than that needed to drive the hydrolysis reaction in the reactor, the gas from the reservoir can be made available much sooner for introduction to the exhaust.

However, preferably, an electric heating element is provided for initially heating the contents of the reservoir which may be used in isolation or in combination with the heat supplied by the hot exhaust gasses.

In another preferred arrangement the electric heater is used on start up to supplement the heat transfer from the hot exhaust gas thus enabling a faster reaction of the aqueous ammonium carbamate. Preferably once the system is up to operational temperature the electric heating element is not used and the temperature of the reservoir is substantially maintained by the exhaust gas. In periods of low engine load when the exhaust gas is relatively cool the electric heater may be used to supplement the heating effect of the hot exhaust gas. When an electric heater is used during cold start the heater is preferably turned on before the IC engine is started such that the aqueous ammonium carbamate within the reservoir is substantially thermally decomposed into ammonia-containing gas such that it is immediately available on start up of the engine.

In one preferred arrangement the reservoir is isolated from direct contact with the hot exhaust gas by an air gap, optionally containing an insulating material, and is provided with an electric heating element. Heat transfer across the air gap is sufficient to produce the majority of the heat needed to maintain the reservoir at an elevated temperature under operating conditions and the electric heater is used in start up and, if needed, to supplement the heating effect of the heat transfer with the exhaust gas.

Preferably the reservoir has a means of losing heat to the environment such that a balance of heat input to heat output can be achieved approximately at its operating temperature such that continued input of heat does not cause the reservoir to continue to rise.

In an alternative arrangement where it is preferable to control the temperature of the reservoir independently of the exhaust gas temperature, the reservoir is placed completely externally of the exhaust conduit and preferably is heated by means of its proximity to the exhaust conduit. Preferably an electric heater is provided for use on start up to thermally decompose the aqueous ammonium carbamate as described above. The electric heater, or an additional heater, may optionally also heat the entire outer surface of the reservoir to ensure no re-condensation of the gas occurs during start up. Preferably, once the system is up to operational temperature the electric heating element(s) is not used and heat input to the reservoir is provided by radiated and conducted heat from the exhaust gas. Where more accurate control of the temperature of the reservoir is required a variable cooling circuit is provided operable to remove excess heat and maintain the reservoir at a substantially constant temperature less than the temperature of the exhaust gas. Preferably this cooling circuit is either a part of the engine cooling circuit or has a heat exchanger to transfer heat to the engine cooling or lubrication circuit. Preferably the reservoir is maintained at a temperature between 125 and 250 degrees centigrade, more preferably between 180 and 225 degrees centigrade.

In one preferred arrangement the reservoir is substantially positioned externally from the exhaust conduit but has a section that extends into the exhaust conduit for heat transfer arranged such that any liquid within the reservoir drains toward the section extending into the exhaust conduit. On start up any liquid within this section is directly acted on by the hot exhaust gas converting it to ammonia-containing gas. Preferably the part of the reservoir extending into the exhaust conduit comprises a heat pipe.

A system of the invention may include any one or more of the preferred features referred to above.

The invention will now be described, by way of example only, with reference to the following drawings in which:

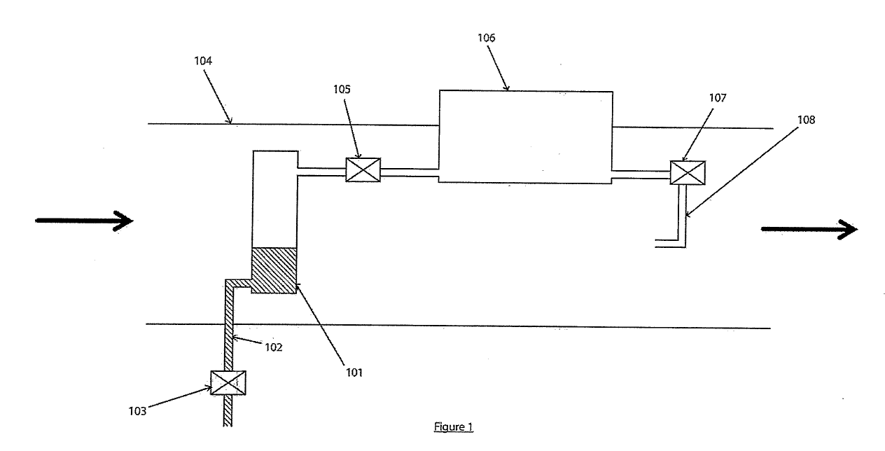

FIG. 1 is an embodiment of a system according to the invention;

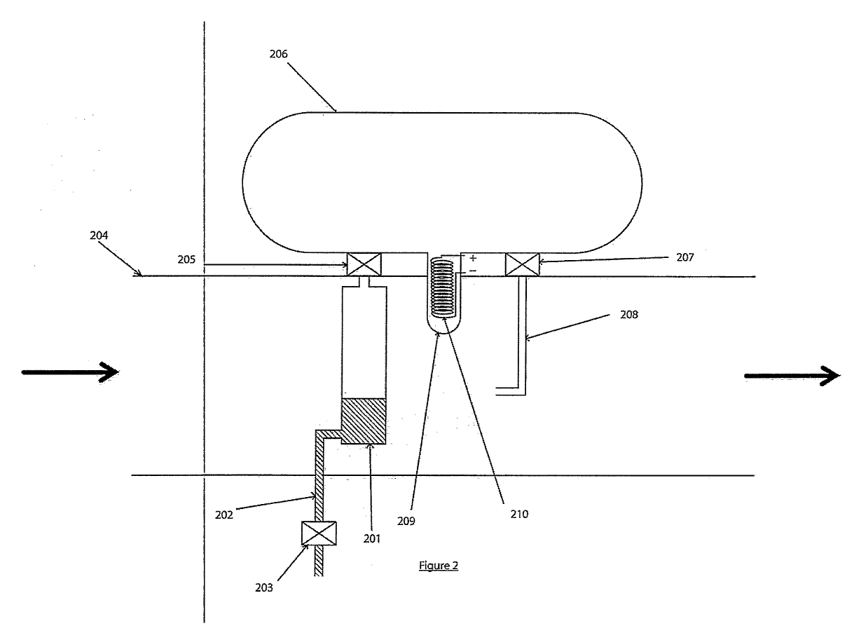

FIG. 2 is an alternative embodiment of the invention incorporating a heat pipe;

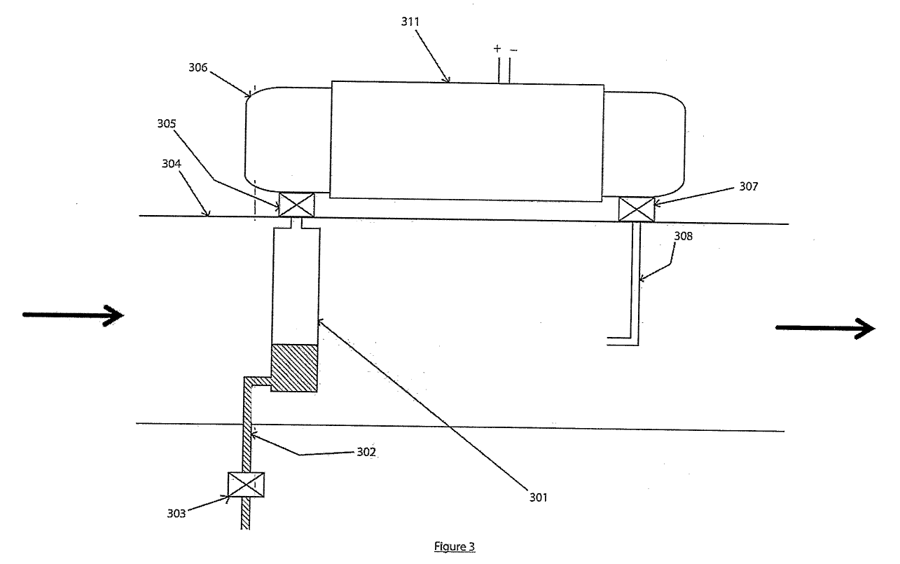

FIG. 3 is an alternative embodiment of the invention incorporating electric heating;

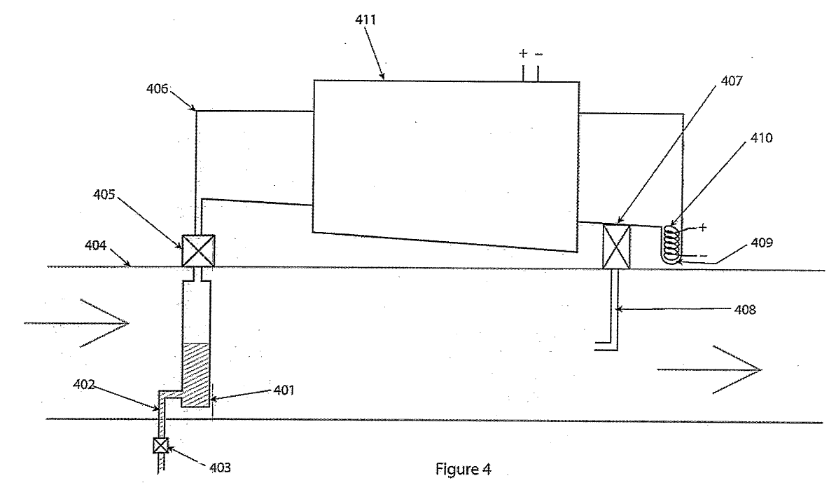

FIG. 4 is an alternative embodiment of the invention incorporating electric heating and a heat pipe;

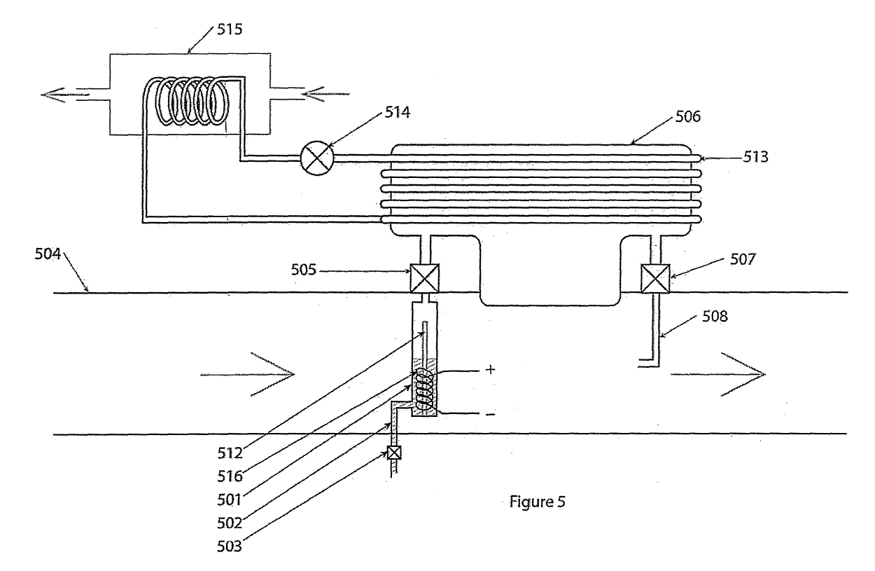

FIG. 5 is an alternative embodiment of the invention incorporating a cooling system;

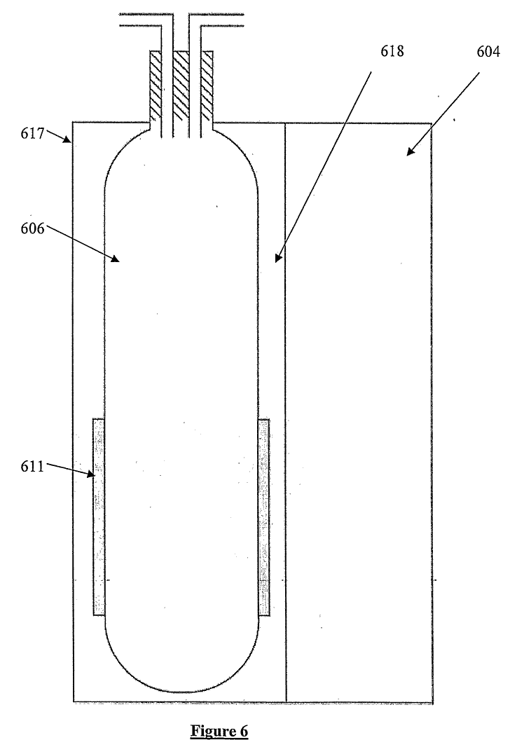

FIG. 6 is a vertical cross section showing a reservoir adjacent the exhaust conduit; and

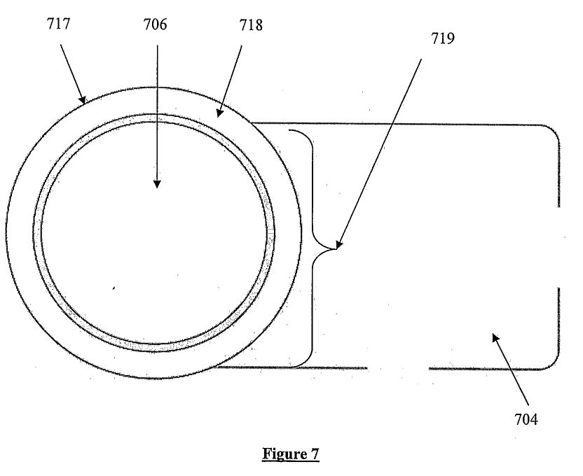

FIG. 7 is a horizontal cross section through the arrangement shown in FIG. 6.

Referring to FIG. 1 a system of the invention is shown which comprises a reactor 101 fed through an inlet 102 with a supply of pressurised aqueous urea solution. The urea is approximately 32% urea by volume, ideally AdBlue available from GreenChem Holdings B.V. The rate of supply is regulated by a pump 103 which is controlled in response to a liquid level indicator (not shown) situated within the reactor 101 to maintain the reactor 101 in a partially full condition. The reactor 101 is situated within the exhaust conduit 104 of an IC engine such that the flow of hot exhaust gas passes over the reactor 101 heating the urea therein. As the temperature rises the urea starts to break down by hydrolysis producing ammonia-containing gas, thus raising the pressure in the head space in the reactor 101 above the liquid level. A pressure control valve 105 is situated towards the top of the reactor 101 and once the pressure within the reactor 101 reaches a set pressure, preferably about twenty bar, any excess gas produced passes through the pressure control valve 105 thereby maintaining the pressure within the reactor 101 substantially constant. The temperature is also maintained substantially constant giving substantially constant operating conditions for the hydrolysis process. After passing through the pressure control valve the ammonia-containing gas enters a reservoir 106 which is situated partially within, and partially outside of, the exhaust conduit 104. The reservoir 106 has one section within the exhaust conduit 104 which is heated by the exhaust gas passing over it which prevents the ammonia-containing gas from condensing or crystallising during normal operation of the engine, and has a second section external to the flow of the exhaust gasses which allows for heat loss from the reservoir 106 such its temperature is lower than that of the reactor 101. The ammonia-containing gas is however still maintained at an elevated temperature and at a pressure above those of the exhaust gasses. A valve 107 is controlled to release gas from the reservoir 106 into the exhaust gas flowing through the conduit 104 via nozzle 108. The ammonia-containing gas then passes with the exhaust gasses through an SCR catalyst (not shown) where it reacts with the NOx in the exhaust gas on the surface of the SCR catalyst resulting in reduced NOx emissions. When the IC engine is shut down and therefore the exhaust gasses stop flowing, it loses heat to its environment and the system will gradually cool down. As it does so the hydrolysis process will stop and the ammonia-containing gas within the reservoir 106 will start to condense, eventually forming a pool of aqueous solution of ammonium carbamate (which may also contain a small amount of ammonia and carbon dioxide) in the base of the reservoir. As the condensation occurs the pressure within the reservoir 106 will drop eventually reaching a pressure which is approximately atmospheric pressure or slightly below. When the IC engine is restarted the hot exhaust gas will start to flow over the reactor 101 and the reservoir 106 thereby heating them. However the reactor 101 will take a finite amount of time to reach its operating pressure and temperature before it can produce more ammonia-containing gas. In the interim, the pool of aqueous ammonium carbamate in reservoir 106 will be thermally decomposed and revert back into its previous gaseous form and be available for use in a shorter time than the new ammonia-containing gas produced by the reactor 101. This allows for ammonia containing gas to be applied to the hot exhaust gas for SCR sooner after start-up of the engine, reducing the NOx emissions in the initial period prior to the reactor producing ammonia-containing gas.

Referring to FIG. 2 another embodiment of the invention is shown in which a reactor 201 is fed in the same way as in FIG. 1 by conduit 202 and pump 203. In this embodiment the reactor 201 ends at back pressure valve 205 located adjacent to, but externally of, the exhaust conduit 204. The majority of the reservoir 206 is situated externally of the exhaust conduit 204 and has a valve 207 for controlling the flow of the ammonia-containing gas from the reservoir 206 into the exhaust conduit 204 via a nozzle 208 to mix with the hot exhaust gas passing therein. The reservoir includes a small heat pipe 209 which extends through the exhaust conduit 204 and is in direct contact with the exhaust gas. The general operation of the system is as described in reference to FIG. 1. The reservoir 201 is shaped such that when the IC engine is shut down and the cooling of the system condenses the ammonia-containing gas, the condensate will collect in the heat pipe 209. On start up, therefore, the condensate is all in contact with the hot exhaust gas. In addition, a supplementary electric heater 210 is provided such that additional heat can be put into the condensate to accelerate its re-conversion back to gaseous form, thereby reducing the NOx emissions by further reducing the time lag between start up of the IC engine and having ammonia-containing gas ready for addition to the system for use in SCR. During normal running of the system, once it is up to temperature the electric heater 210 is turned off, the reservoir being maintained at an elevated temperature by heat transfer conduct between the hot exhaust gasses and the part of the reservoir 206 within the exhaust conduit 204.

Referring to FIG. 3 another embodiment of the system is shown in which the reservoir 301, conduit 302, pump 303, and pressure control valve 305 operate in the same manner as their corresponding parts in FIG. 2. The reservoir 306 is situated completely externally form the exhaust conduit 304 and as such is not directly heated by the hot exhaust gasses. The reservoir is joined to the exhaust conduit via valve 307 and nozzle 308 to allow the ammonia-containing gas as within the reservoir to be applied to the exhaust gas prior to them flowing together through an SCR catalyst (not shown). The reservoir 306 is heated by an electric heater 311 which raises the temperature of the reservoir 306 to, and maintains it at, at a temperature above which the gasses therein will start to condense. The heater is controlled to maintain the reservoir at a substantially constant temperature in the region of 200 degrees centigrade.

Referring to FIG. 4 a system is shown which is a combination of FIGS. 2 and 3, and the components work in the same manner. The reservoir 406 is provided with a small heat pipe 409 situated at the bottom of the reservoir 406 but external to the exhaust conduit 404. When the IC engine is turned of and the ammonia-containing gas within the reservoir 406 condenses, the resulting solution will collect in the heat pipe 409. The heat pipe is provided with an electric heater 410 which is of a high power to quickly reconvert the solution to ammonia-containing gas ready for dosing. The reservoir 406 is also provided with a general heater 411, which may be of lower power for the general heating of the reservoir 406.

Referring to FIG. 5 a system of the invention is shown which comprises a reactor 501 fed by an inlet 502 with a supply of pressurised aqueous urea. The flow of supply is regulated by a pump 503 which is controlled in response to a liquid level indicator 512 situated within the reactor 501 to maintain the reactor 501 in a partially full condition. The reactor 501 is situated within the exhaust conduit 504 of an IC engine such that the flow of hot exhaust gas passes over the reactor 501 heating the urea therein hydrolysing it to produce reaction gasses which are a mixture of ammonia, H₂O and CO₂ A pressure control valve 505 is situated towards the top of the reactor 501 and once the pressure within the reactor 501 reaches a set pressure, preferably about twenty bar, any excess gas produced passes through the pressure control valve 505 thereby maintaining the pressure within the reactor 501 substantially constant. After passing through the pressure control valve the ammonia-containing gas enters a reservoir 506 which is situated partially within, and partially outside of, the exhaust conduit 504. The reservoir 506 has one section within the exhaust conduit 504 which is heated by the exhaust gas passing over it which prevents the ammonia-containing gas from condensing or crystallising, and has a second section external to the flow of the exhaust gasses which allows for heat loss from the reservoir 506 such that its operating temperature will be lower than that of the reactor 501. As the reservoir 506 may be in an environment which has an elevated temperature, the natural temperature loss through the reservoir 506 to its environment may not be sufficient, and there is no possibility to control the final temperature as it will be dependent on ambient temperature. Therefore the reservoir 506 is surrounded by a cooling coil 513 which is pumped by a variable speed pump 514 through a heat exchanger 515. The heat exchanger 515 is in turn cooled by heat exchange with the cooling system of the IC engine which typically maintains a fairly constant temperature. The speed of pump 514 can be controlled to maintain a substantially constant temperature within the reservoir 506. A valve 507 is controlled to release ammonia-containing gasses from the reservoir 506 into the exhaust gas flowing through the conduit 504 via nozzle 508. The ammonia-containing gas then passes with the exhaust gasses through an SCR catalyst (not shown) where they convert the NOx in the exhaust. When the IC engine is shut down and therefore the exhaust gasses stop flowing, as it loses heat to its environment, the system will gradually cool down. As it does so the hydrolysis process will stop and the ammonia-containing gas within the reservoir 506 will start to condense, eventually forming a pool of aqueous solution of ammonium carbamate (which may also contain a small amount of ammonia and carbon dioxide) in the base of the reservoir. When the IC engine is restarted the hot exhaust gas will start to flow over the reactor 501 and the reservoir 506 heating them up. The pump 514 will not start to circulate the cooling fluid within the coil 513 until the reservoir reaches its operating parameters. The reservoir 501 will function as described above and will take a finite amount of time to reach its operating pressure and temperature before it can produce more ammonia-containing gas. In the interim, the pool of aqueous ammonium carbamate within the reactor 506 will be thermally decomposed and revert back into its previous gaseous form and be available for use in a shorter time than the new ammonia-containing gas being produced by the reactor 501. This allows for the ammonia containing gas to be applied to the hot exhaust gas sooner to start up of the engine, reducing the NOx emissions in the initial period prior to the reactor producing ammonia-containing gas. An auxiliary heater 516 in the reactor 501 can be used during start up to supplement the heat from the exhaust gasses to decrease the time taken for the reactor to reach operating parameters.

Referring to FIGS. 4 and 5, the introduction of the heater 516 of FIG. 5 into the system of FIG. 4 would enable a system wherein prior to the starting of the IC engine heaters 516 and 409 and 411 could be powered to bring the system up to operating temperature such that it is ready to apply ammonia-containing gas to the exhaust gasses as soon as the IC engine is started, thereby eliminating any delay between the starting of the engine, and therefore the production of NOx, and its reduction by the system of the invention.

Referring to FIG. 6 a section view of the reservoir 606 of a system is shown located in a chamber 617 adjacent the exhaust conduit 604. An air gap 618 separates the reservoir 606 from the conduit and heat transfer across the air gap 618 heats the reservoir 606. The rate of heat transfer across this gap may be controlled by adding an insulation material in the air gap 618. The reservoir 606 has an inlet and outlet with associated dosing valve (not shown). The reservoir 606 has a heating element 611 associated therewith. The heater 611 can be used prior to, or during, start up to heat the condensate in the reservoir 606 and revert it to its gaseous state ready for dosing into the exhaust gas flowing through the conduit 604.

Referring to FIG. 7 a top view of FIG. 6 is shown. The reservoir 706 is located in a chamber 717 adjacent the exhaust conduit 704 and has an air gap 718 surrounding it. A first part 719 of the surface of the chamber 717 forms is in contact with the hot exhaust gasses and the remainder of the surface chamber 717 is exposed to the atmosphere and heat is lost through that part. Preferably the ration of the first part 719 of the remainder of the surface is such that at some operating conditions an equilibrium of heat input to heat lost is achieved so that the reservoir 706 is maintained at a substantially constant temperature.

It will be appreciated that within the scope of the invention various components described herein with reference to one or other of the embodiments are interchangeable. For example systems falling within the scope of the invention may include a combination of features not explicitly described in respect to any particular embodiment.

1. An apparatus for generating an ammonia-containing gas for use in the selective catalytic reduction of NOx contained in the exhaust gases of an IC engine, the apparatus comprising:
a) a hydrolysis reactor for containing an aqueous solution of urea (as hereinbefore defined)
b) means for heating the solution to an elevated temperature by way of heat exchange with said exhaust gases, whereby the urea is hydrolysed and the ammonia containing gases are liberated;
c) valve means operable between a substantially closed position for enabling the pressure of the ammonia-containing gas to attain a predetermined elevated pressure within the reactor, and an open position when the gas is above said predetermined pressure;
d) a reservoir having an inlet for receiving all of the ammonia-containing gas discharged from the reactor when said valve is in its open position, and an outlet for feeding ammonia-containing gas to the exhaust gases, the reservoir serving to store ammonia-containing gas during operation of the IC engine and, following the IC engine being switched off, ammonia-containing gas condensate; and
e) means for heating the reservoir,
the arrangement being such that on cold start-up of the IC engine, the means for heating the reservoir is operable to decompose the condensate into ammonia-containing gas.

2. The apparatus according to claim 1 wherein, during normal operation, the reservoir is maintained at a pressure above the pressure within the exhaust conduit.

3. The apparatus according to claim 1 wherein the reactor is solely heated by thermal heat transfer with the exhaust gas.

4. The apparatus according to claim 1, wherein the reactor is placed within the exhaust conduit such that there is direct contact between the hot exhaust gas and at least a part of the exterior surface of the reactor.

5. The apparatus according to claim 1 wherein the reactor is partially heated by electrical heating means.

6. The apparatus according to claim 5 wherein the reactor is initially heated by both heat exchange with the exhaust conduit and electric means and, once the exhaust reactor is at operating temperature and pressure, the electric heating means is turned off and the reactor is maintained at operating temperature and pressure by heat exchange with the exhaust gas only.

7. The apparatus according to claim 5 wherein the reactor is preheated by electric heating means prior to the IC engine being started such that the reactor can start to replenish the gas being drawn from the reservoir substantially immediately from the time the IC engine is started.

8. The apparatus according to claim 1, wherein during operation the reservoir is maintained at an elevated temperature to prevent the gasses therein condensing.

9. The apparatus according to claim 8 wherein the reservoir is maintained at a substantially constant temperature.

10. The apparatus according to claim 8 wherein the heat supplied to the reservoir is supplied by the heat transfer from the hot exhaust gas.

11. The apparatus according to claim 10 wherein the reservoir partially protrudes into the exhaust conduit.

12. The apparatus according to claim 11 wherein the reservoir is shaped such that any liquids condensing therein drain under the influence of gravity to the part of the reactor that protrudes into the exhaust conduit such that on start up the condensed liquid is heated by the exhaust gas.

13. The apparatus according to claim 10 wherein the reservoir is situated entirely in the exhaust conduit.

14. The apparatus according to claim 10 wherein the reservoir is isolated from direct contact with the hot exhaust gas by an air gap.

15. The apparatus according to claim 14 wherein the air gap contains an insulating material.

16. The apparatus according to claim 14 wherein the reservoir has a means of losing heat to the environment such that, in at least some operating conditions, a balance of heat input to heat output is effected such that continued input of heat does not cause the reservoir to continue to rise.

17. The apparatus according to claim 8, wherein an electric heater is provided for heating the contents of the reservoir.

18. The apparatus according to claim 17 wherein the electric heater is used on start up to supplement the heat transfer from the hot exhaust gas.

19. The apparatus according to claim 17 wherein, in periods of low engine load when the exhaust gas is relatively cool, the electric heater is used to supplement the heating effect of the hot exhaust gas.

20. The apparatus according to claim 17, wherein the electric heater is turned on before the IC engine is started such that the aqueous ammonium carbamate within the reservoir is substantially reverted to ammonia-containing gas such that it is immediately available for exhaust gas treatment on start up of the engine.

20. (canceled)

21. The apparatus according to claim 8 wherein the heat supplied to the reservoir is supplied by the heat transfer from the hot exhaust and wherein a variable cooling circuit is provided operable to remove excess heat and maintain the reservoir at a substantially constant temperature less than the temperature of the exhaust gas.

22. The apparatus according to claim 21 wherein the cooling circuit comprises heat exchange with the cooling circuit.

23. The apparatus according to claim 1, wherein the reservoir is maintained at a temperature between 125 and 250 degrees centigrade.

24. The apparatus according to claim 23 wherein the reservoir is maintained at a temperature between 180 and 225 degrees centigrade.

25. The apparatus according to claim 1, wherein as the reservoir cools the pressure therein subsides to substantially atmospheric pressure.
